(19) United States
(12) Patent Application Publication
(10) Pub. No.: US 2004/0155049 A1
(43) Pub. Date: Aug. 12, 2004

(54) Pill sorting device and method of use thereof

(75) Inventors: Jamison J. Float, Westerville, OH (US); Roger D. Boster II, Blacklick, OH (US)

Correspondence Address: DARBY & DARBY P.C., Post Office Box 5257, New York, NY, 10150-5257, US

(73) Assignee: ARTROMICK INTERNATIONAL, INC.

(21) Appl. No.: 10/361,793

(22) Filed: Feb. 10, 2003

(51) Int. Cl. G07F 11/00

(52) U.S. Cl. 221/12

(57) ABSTRACT

A pill sorting apparatus is provided and includes a system for retrieving pills from a container and then dispensing those retrieved pills to a bin where they can be administered to a patient by a healthcare professional. The pill sorter includes a sorting mechanism that prevents excess pills from being delivered to the bin marked for patient delivery and instead, an automated system directs the excess pills to a bin where the pills are collected for return to the pill source.

### TECHNICAL FIELD

The present invention generally relates to the field of medical care, and more specifically to a pill sorting apparatus.

### BACKGROUND

The issue of medication errors is one of the most critical health care challenges currently facing the United States and the medical and pharmaceutical professions. A substantial number of hospitalized Americans die each year due to medical errors, and the majority of these errors are medicating errors. Accurate medicating of patients is one of the most important aspects of the medical care industry.

Health care providers to the long term care industry have continued with the archaic, manual methods of medication administering systems, such as the unit dose system, despite the errors that can result and the potential safety concerns of the patient. The problem of getting the correct medication, to the correct patient and in the correct dose continues today. Many of the deaths caused by incorrect medicating of patients are a result of giving the wrong drug to a patient, or giving a patient the wrong dose.

Devices have been developed which are capable of retrieving and dispensing pills. U.S. Pat. No. 5,480,062 to Rogers et al. discloses a vacuum-operated medicine dispenser which utilizes a particular probe tip for every different type of pill. The cost effectiveness and efficiency of such a system appear low and inadequate for medical community's needs due in part to the vast number of different types of medication. For example, one will readily recognize that pills come in a number of different sizes as well as a number of different shapes and therefore, a system that utilizes different probe tips for different types of pill will be expensive due to the sheer number of probe tips that will be required. In addition, this type of system is cumbersome and ineffective since one patient may require a pill regiment consisting of a number of different pills and therefore, this type of medical dispenser would require repeated removal and attachment of different probe tips. This greatly increases the time required for each pill dispensing operation and as a result the entire dispensing operation is labor intensive and costly.

Thus there exists a continuing need for an apparatus that can retrieve and dispense a controlled number of medications for administration to a patient in an accurate and efficient manner and substantially independent of the size and/or shape of the medication.

### SUMMARY

A pill sorting apparatus is provided and includes a system for retrieving pills from a container and then dispensing those retrieved pills to a bin where they can be administered to a patient by a healthcare professional. The pill sorter includes a main housing containing the major components of the pill sorter.

In accordance with one aspect of the present invention, the pill sorter includes a probe which houses the spring-loaded probe having a universal probe tip at the end thereof, and a first member positioned to receive at least one pill retrieved from a pill supply that is linked to a transporter. The transporter preferably having a portion disposed proximate the first member to receive the pill from the first member and constructed to align pills in series when two or more pills are simultaneously disposed on the transporter and to direct the pills along a path to a first location. A sensor is situated proximate the first location and positioned to sense the presence of the pill as the pill passes through the first location with the sensor generating a control signal in response to the passage of the pill. The sensor is linked to a deflector disposed proximate the first location and being positionable between first and second positions, wherein the first position diverts the at least one pill to a first receptacle and the second position diverts the at least one pill to a second receptacle. The pill sorter further includes a controller which allows the components of the pill sorter to communicate with each other thereby ensuring proper functioning of the apparatus. A main function of the controller is to instruct the deflector to move into its second position after a pill has been placed into a bin for retrieval so that extra pills are then returned to the pill storage containers.

In accordance with another aspect of the present invention, a method for handling a pill once the pill is released from a probe involves discharging the pill onto a pill chute for transfer to a transporter which moves the pill in a controlled direction. Urging of the pill against an abutment proximate to the transporter is accomplished by the pill chute causing the pills to slide against the abutment. The abutment arranges the pills in a linear series in the controlled direction, if there are multiple pills on the transporter, and delivers a first pill in the linear series to a first receptacle. A sensor senses the first pill as it is delivered to a first receptacle and generates a control signal that is transmitted to a controller. The controller positions a deflector, in response to the control signal, to a second position so that any subsequent pills in the linear series are directed to a second receptacle. The first receptacle is flagged for delivery to a patient and the second receptacle collects extra pills for delivery back to a pill storage container.

### BRIEF DESCRIPTION OF THE DRAWINGS

The foregoing and other features of the present invention will be more readily apparent from the following detailed description and drawings of illustrative embodiments of the invention in which:

FIG. 1 is a perspective view of a pill sorting apparatus according to one exemplary embodiment;

FIG. 2 is a perspective view of the pill sorting apparatus of FIG. 1, shown rotated 90° relative to FIG. 1;

FIG. 3 is a top plan view of the pill sorting apparatus of FIG. 1;

FIG. 4 is a cross-sectional view taken along line IV-IV of FIG. 4;

FIG. 5 is cross-sectional view taken along line V-V of FIG. 4;

FIG. 6 is a top plan view of a section of a transporting mechanism illustrating a sorter belt and sorter wall;

FIG. 7 is a side elevational view of the pill sorting apparatus of FIG. 1;

FIG. 8 is a cross-sectional view taken along line VIII-VIII of FIG. 7;

FIG. 9 is a cross-sectional view taken along line IX-IX of FIG. 7;

FIGS. 10-14 illustrate a section of the transporter mechanism of FIG. 6 at consecutive stages of an arranging process; and

FIG. 15 is an illustration of a medication cart incorporating the pill sorting apparatus of FIG. 1.

### DETAILED DESCRIPTION OF THE PREFERRED EMBODIMENTS

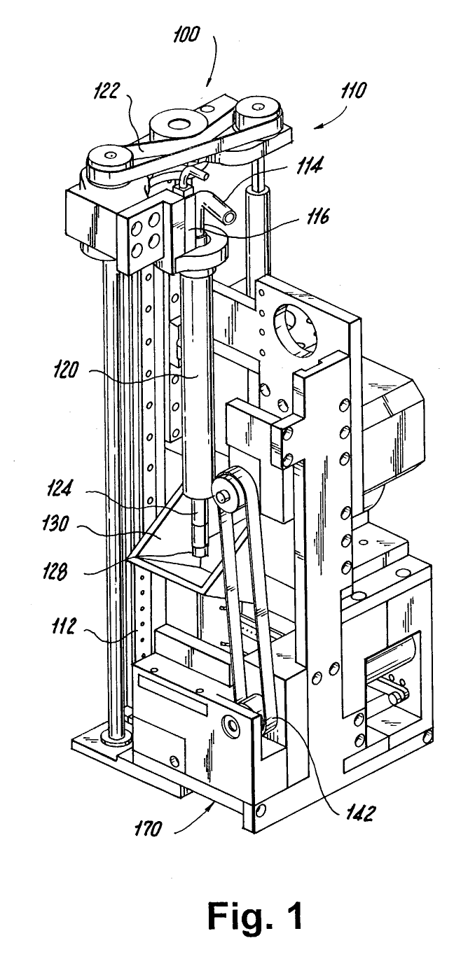

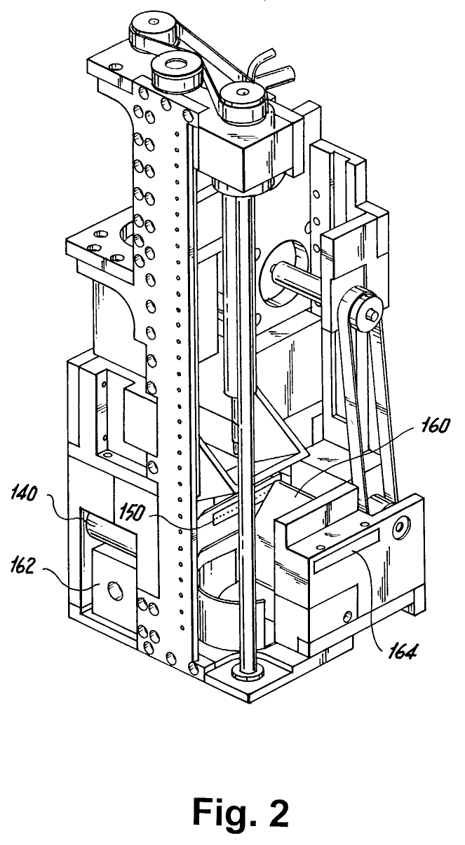

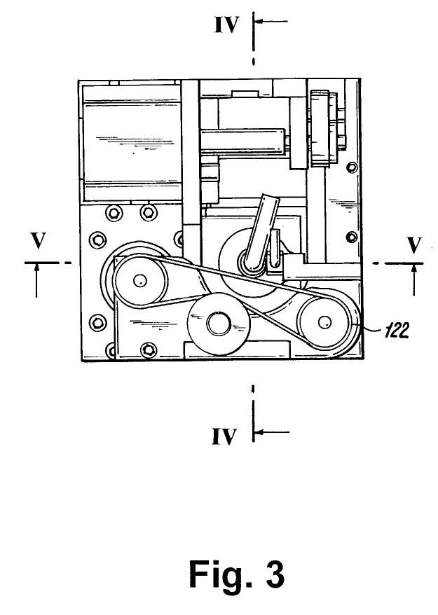

Referring now to the drawings, a pill sorting apparatus (pill sorter) 100 according to one exemplary embodiment is shown in perspective view in FIGS. 1 and 2. The pill sorter 100 generally includes a system for retrieving one or more pills from a container and then dispensing the retrieved pills to a receptacle (e.g., container, bin, etc.) where they can be administered to a patient by a healthcare professional. As used herein, a “pill” means a tablet, a gel cap or other solid dosage form of a medication. The pill sorter 100 includes a main housing 110 that contains the major components of the pill sorter 100. One of the major components within the main housing 110 is a movable probe 120 for retrieving one or more pills from a pill source (such as a pill canister) as will be described later. The probe 120 includes a housing and has at one end thereof a spring-loaded probe section 124 that itself includes a universal probe tip 128 at a distal end thereof. The pill sorter 100 also includes a pill chute 130 that receives the one or more pill that has been retrieved by the probe 120, and one section of the pill chute 130 communicates with a transporter 140 that is configured to deliver the one or more pills from one location to another location. A sensor 150 is positioned to detect the passage of one pill along a select location and then generate a control signal under selected conditions, such as the detection of the pill. A deflector 160 is provided and pivotally mounted to the housing 110 for directing pills retrieved by the probe 120 to individual storage receptacles, such as containers or bins, that are located at particular locations.

The pill sorter 100 further includes a controller 180 which allows the components of the pill sorter 100 to communicate with each other thereby ensuring proper functioning of the apparatus. A main function of the controller 180 is to instruct the deflector 160 to move to another position after a pill has been detected by the sensor 150 and it has been collected in a first pill storage receptacle or container that is earmarked for delivery to a specific patient. When the deflector 160 moves to the other position, any subsequent pills (extra pills) traveling on the transporter 140 are directed to a second pill storage receptacle or container that collects the extra pills, which are returned later to the pill source (pill storage container). The following is a detailed discussion of the individual working components of the pill sorter 100 and its operation.

The probe 120 according to one exemplary embodiment houses the spring-loaded probe section 124 and the universal probe tip 128. The probe 120 is connected to and supported by the main housing 110 and it moves along a vertical axis so that the spring-loaded probe section 124, may descend into a pill storage container to retrieve the desired one or more pills. The spring-loaded probe section 124 protects the universal probe tip 128 from damage upon contacting force with the pills or the base of a pill storage container. More specifically, the spring-loaded probe 124 is spring biased and is positionable between an extended position and a retracted position which results when a force is applied to the probe tip 128.

By providing a spring-loaded universal probe tip 128, a single probe 120 is usable to retrieve pills having different sizes, shapes, and weights. A single, universal probe tip 128 avoids the need to switch probe tips each time it is desired to retrieve pills of different sizes and/or shapes and therefore, the use of a universal probe tip 128 reduces the complexity of the pill sorting operation as well as the associated operational costs and further increases speed of operation of the pill sorter 100. The probe 120 moves along a vertical axis preferably by way of a linear guide 112 which is connected to the main housing 110. The linear guide 112 provides a vertical track for the probe 120 to travel within, resulting in the probe 120 being configured to be raised and lowered relative to pill storage containers. A probe drive system 122 (e.g., a conventional belt drive system with an electric motor) is one exemplary mechanism for driving the probe 120 along the linear guide 112. The probe drive system 122 communicates with the controller 180 which generates and sends control signals to the probe drive system 122 to position the probe 120 at a given location, including at a start position of the pill retrieval process.

The probe 120 can be powered in a number of different ways that permit the probe tip 128 to retrieve one or more pills from a pill storage container (pill source) and retain the one or more pills as the probe 120 is guided along the linear guide 112 to a location where the one or more pills can then be delivered to the pill chute 130. For example, the probe 120 can be powered with a vacuum which applies a negative pressure (suction) within the housing, including the probe tip 128, of the probe 120. The probe 120 is therefore attached to a vacuum source (not shown) using conventional techniques, such as the use of a vacuum conduit connected to a pump. The vacuum source thus provides suction power to the probe tip 128 through the probe housing which can be connected to the vacuum source through a vacuum line 114. The connection between the probe 120 and the vacuum source through the vacuum line 114 is of a type that the probe 120 can freely travel in the vertical direction along the linear guide 112.

The suction power provided by the vacuum allows the probe tip 128 to collect one or more pills from a pill storage container, hold the one or more pills at the probe tip 128 and transfer the one or more pills to another location. Optionally, the vacuum source is adapted to provide a positive pressure puff between pill retrievals for the purpose of exhausting any foreign particles within the probe 120. Alternatively, the pill sorter 100 is adapted to include an alcohol bath or wipe for cleaning the exterior of the probe after retrieval of a pill of one type and before retrieving a pill of a different type.

The pill chute 130 is situated proximate to the probe tip 128 when the probe tip 128 is in a retracted position and is positioned to divert pills released by the probe tip 128 to the transporter 140. The pill chute 130 is essentially a transferring bin preferably having angled, converging surfaces so that the pill can slide down the surfaces from an open region at its top to an open bottom region to cause the pill to be diverted to the transporter 140. Of course, other shapes can be used so long as the pill chute 130 serves to deliver the pill to the transporter 140. In alternative arrangements, pills can be transferred from the probe tip 128 to a transporter 140 by mechanisms other than a moveable chute 130. For example, the probe 120 can selectively pivot to release pills toward the transporter 140 under control of the controller 180. In other words, the probe 120 can move into a drop position where it is positioned above the transporter 140 so that when the vacuum source is deactivate, the one or m ore pills are delivered to the transporter 140.

In one exemplary embodiment, the pill chute 130 is pivotally connected, at the top edge, to the main housing 110 of the pill sorter 100 and is positionable between an open position and a closed position. The pill chute 130 is positioned, initially, in the closed position so that the probe 120 can descend along the linear guide 112 to pill storage containers free of obstruction (interference) by the pill chute 130. The reason for the initial situation of the pill chute 130 in the closed position is because when the pill chute 130 is positioned in its open position, the pill chute 130 is located below the probe 120 and interferes with the probe 120 descending to the pill storage containers. The ascending of the probe 120 to a location that is above the pill chute 130 allows the pill chute 130 to be moved into the open position to receive a pill from the tip probe 128. The pill chute 130 is then instructed to return to the closed position after the pill chute 130 has received the pill from the probe tip 128. Positioning the pill chute 130 in the closed position, combined with the forces of gravity and the slope of the pill chute 130 allow a pill dropped into the pill chute 130 to slide downwardly to the transporter 140 without the need for a complicated mechanical transporting system.

In alternative arrangements, pills can be transferred from the probe tip 128 to a transporter 140 by mechanisms other than a moveable chute 130. For example and as previously mentioned, the probe 120 can selectively pivot to release pills toward the transporter 140 under control of the controller 180.

Generally below the probe tip 128 and proximate to a bottom edge of the pill chute 130 is the transporter 140. The transporter 140 preferably is an apparatus that conveys an item from one location to another location. One exemplary transporter 140 is a conveyor belt or drive belt based system that includes a conveyor belt 141 arranged in an endless manner (about rollers or the like) and having a pill drop location 144 proximate to the bottom edge of the pill chute 130 and a run-off location 148 downstream of the pill drop location 144. The run-off location 148 is where the pills disposed on the transporter 140 are directed from the transporter 140 and past the sensor 150. The transporter 140 further includes a transporter drive system 142 and a pill sorter mechanism 146. The transporter drive system 142 advances the conveyor belt 141 such that pills on the conveyor belt 141 move in a controlled direction from the pill drop location 144 to the run-off location 148. When the transporter drive system 142 is embodied as a belt-driven system, a roller assembly and a power source, e.g., an electric motor (not shown), are provided to move the belt 141.

The pill sorter mechanism 146 is generally a mechanism for ordering the one or more pills that are present on the conveyor belt 141 in such a way that they can be processed in a one-by-one manner. In one exemplary embodiment, the pill sorter mechanism 146 is a rigid member that is contoured so that pills that are delivered to the conveyor belt 141 are aligned in series so that only one pill at a time is delivered to the pill drop location 144 as opposed to a several or more pills. The pill sorter mechanism 146 is thus constructed so that when pills land on the conveyor belt 141 in a random manner, the pills contact a contoured surface that has one end that terminates at the pill drop location 144. The contoured surface thus acts as a guide surface that guides the one or more pills as the pills travel along the conveyor belt 141. The pill sorter mechanism 146 is disposed over a section of the conveyor belt 141 such that the conveyor belt 141 can freely travel thereunderneath; however, a pill is not able to travel underneath the pill sorter mechanism 146 as it travels along the conveyor belt 141.

In one exemplary embodiment, the pill sorter mechanism 146 is a pill sorting wall that extends across a section of the conveyor belt 141 in the above aforementioned manner. One end of the wall 146 begins in an intermediate section of the conveyor belt 141 and the other end of the wall 146 terminates at the pill drop location 144. It will be appreciated that the pill drop location 144 does not have to coincide with the end of the conveyor belt 141 but rather the pill drop location 144 can be spaced from the end of the conveyor belt 141 such that the conveyor belt 141 travels downstream of the pill drop location 144. Because the pill sorter mechanism 146 extends across the entire width of the conveyor belt 141, a pill is prevented from traveling on the conveyor belt 141 downstream of the pill sorter mechanism 146.

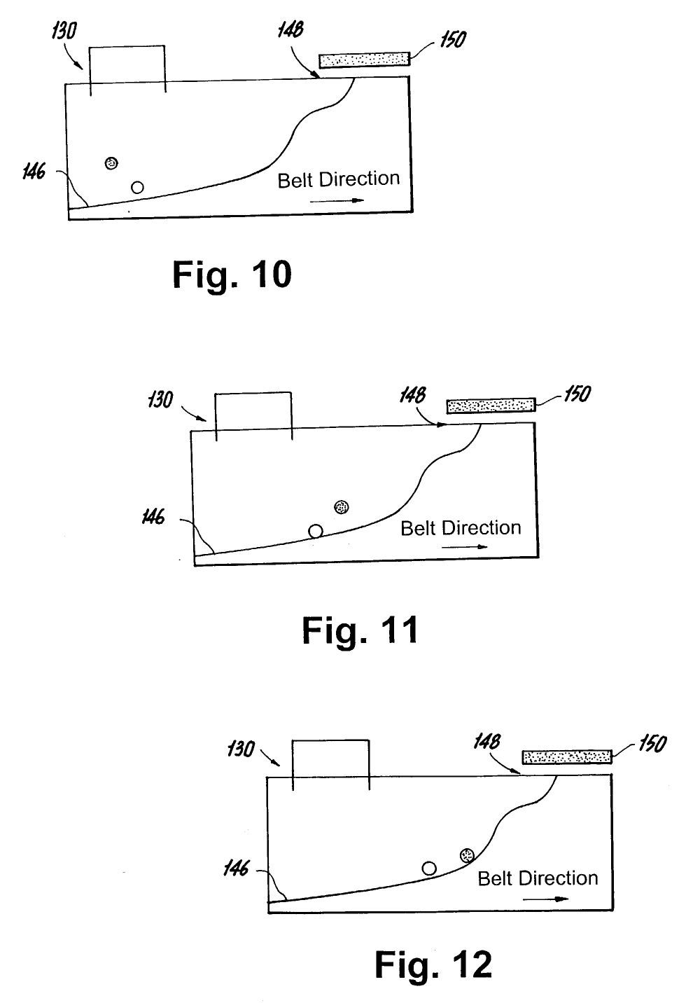

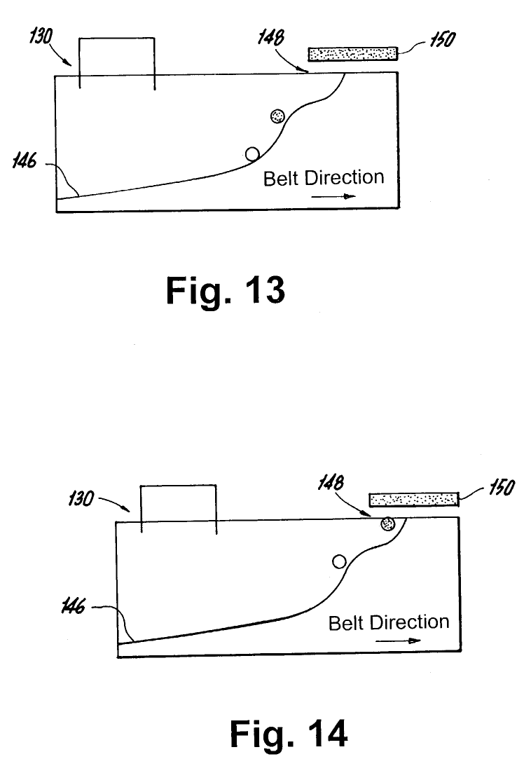

The pill sorting wall 146 is angled across the conveyor belt 141 so that pills traveling along the conveyor belt 141 encounter the pill sorting wall 146 at different locations depending upon the precise location where the pills land and come to a rest on the conveyor belt 141. For example, the conveyor belt 141 has a first side edge and a second side edge with the first end of the pill sorting wall 146 disposed at the first side edge and the conveyor belt 141 is arranged so that the second end of the pill sorting wall 146 is disposed at the second side edge at a location downstream of where the first end of the pill sorting wall 146 intersects the first side edge. Thus, if two pills land on the conveyor belt 141 and a first pill is located closer to the second side edge but upstream of a second pill that is located near the first side edge, the second pill will make contact with the pill sorting wall 146 because it is located closer to the first side edge (where the pill sorting wall 146 begins). The pill (here that second pill) that makes contact with the pill sorting wall 146 is restricted to traveling along the surface of the pill sorting wall 146 since the drive direction of the conveyor belt 141 and the presence of the pill sorting wall 146 itself causes the pill to be driven along the surface of the pill sorting wall 146 in a direction toward the pill drop location 144. Depending upon the precise initial location of the other pill (here the first pill), the other pill can in fact become the first pill that reaches the pill drop location 144 even though this pill initially was further upstream. This happens because if the pill rests on the conveyor belt 141 closer to the second edge, the pill travels a greater distance before it contacts the pill sorting wall 146. Both pills are being driven in the same first direction due to the direction that the conveyor belt 141 is being driven; however, the pill sorting wall 146 causes the pills to travel in a second direction due to contour of the wall 146 while the pill is continuously being driven in the first direction since it still remains sitting on the conveyor belt 141. It will therefore be appreciated that the frictional contact between the pill and the wall 146 reduces the speed at which the pill travels. FIGS. 10-14 illustrate this aspect of the present apparatus in that two pills that land on the belt conveyor 141 are arranged in series by the pill sorting wall 146. In other words, the pill sorting wall 146 causes the pills to line up one after the other as the pills are guided along the pill sorting wall 146 to the pill drop off location 144.

Because of the contour of the pill sorting wall 146 and its angled position across the conveyor belt 141, the pills are arranged in series when more than two pills are disposed onto the conveyor belt 141 from the chute 130. Thus, the pills arrive at the pill drop location 144 in series which permits the pills to be processed one at a time instead of having the risk that two pills side by side are processed as a single pill. The exemplary pill sorting wall 146 has two points of deflection with the last point of deflection causing any two adjacent pills of the series to be spaced even a greater distance apart as the pill is delivered to the pill drop off location 144.

The second deflection point is advantageously provided along the length of the pill sorter wall 146 to increase the distance between the first pill and any subsequent pills disposed on the conveyor belt 141 since the traveling speed of the first pill after the second deflection point of the sorter wall 146 is greater than that of any subsequent pills that have yet to pass the second deflection point. Increasing the distance between the pills better ensures that the sensor 150 has time to generate a control signal to appropriately instruct the controller 180 to position the deflector 160 into either the open or closed positions.

As will be described hereinafter, the pill drop off location 144 is the location where the pill is either delivered along one of two paths, namely it is either directed along a first path where it is collected for a patient or it is directed along a second path where it is collected as an extra pill for return back to the pill source. Thus, it is desirable for two successive pills in series to be spaced slightly apart from one another as they are delivered to this station to avoid the risk that one of the pills is directed to the wrong receptacle by traveling down the wrong path. After the second deflection point, the exemplary pill sorter wall 146 has a generally linear section that extends to the second side edge of the conveyor belt 141 and more specifically, the linear section terminates at the pill drop off location 144.

It will therefore be appreciated that should more than one pill fall onto the transporter 140, the sorter wall 146 aligns the pills in series as the pills advance along the transporter 140. In other words, the belt 141 moves the pills in a controlled direction while the sorter wall 146 urges the pills across the belt, towards the run-off edge 148, thereby aligning the pills sequentially. Aligning pills in series prevents the pills from going through the sensor 150 at the run-off edge 148 simultaneously, which might otherwise cause the sensor 150 to misregister the correct number of pills. Instead, aligning the pills in series allows a first pill to pass through the sensor 150 alone and then a second pill to pass through the sensor thereafter, thereby allowing the sensor 150 to differentiate between the first pill and all other pills that sequentially follow the first pill along the surface of the pill sorter wall 146.

Optionally, the transporter 140 includes an agitator, such as a reciprocating cam or crankshaft, which causes the conveyor belt 141 of the transporter to vibrate. The vibrations prevent pills from going through the sensor 150 at the first location in a stacked formation, i.e. one pill riding on top of a second pill. The agitator causes a second pill that might land on a first pill to bounce onto the transporter 140. Again this can better ensure that the sensor 150 accurately reads the passage of one pill, and not merely two pills posing as one pill. If an agitator is used, the agitator can be activated only for a select time so that the agitation does not otherwise disrupt the order and positioning of the pills on the conveyor belt 141. For example, the agitator can be activated after the pills initially land on the conveyor belt 141 from the chute 130.

The sensor 150 is disposed at or near the pill drop off location 144 and is configured to sense the passage of a pill through the pill drop off location 144. There are a number of different sensors that are suitable for this type of application so long as the sensor is of the type that can detect the presence of the pill as it passes the sensor area. One exemplary sensor 150 is an infrared sensor that includes an infrared transmitter 152 situated at or proximate to the run-off edge 148 and an infrared receiver 154 spaced from the transmitter 152. According to one exemplary embodiment, the drop off location 144 has a run-off edge 148 that in effect is a cliff that the pills drop from after passing thereover.

The infrared transmitter 152 emits a beam to the infrared receiver 154 such that a pill falling from the conveyor belt 141 at the run-off edge 148 trips the infrared beam (by passing therethrough) thereby informing the sensor 150 that a pill has passed. The sensor 150 is in communication with the controller 180 such that when a pill passes through the infrared beam, a signal is sent from the sensor 150 to the controller 180. The controller 180 processes this information and generates a control signal that is sent to the deflector 160 for causing the deflector 160 to assume one of the two positions. The controller 180 can be part of a central processing unit of the pill sorter 100 and the controller 180 is generally a programmable unit that directs the operations performed by the pill sorter 100.

The deflector 160, positionable between a first position and a second position, is situated proximate the sensor 150 and the transporter 140. When the run-off edge 148 is a cliff structure and the pills fall off the run-off edge and fall by gravity through the sensor 150, the deflector 160 is disposed below both the run-off edge 148 and the sensor 150 since the deflector 160 serves to direct the falling pill either to one storage receptacle or to another storage receptacle.

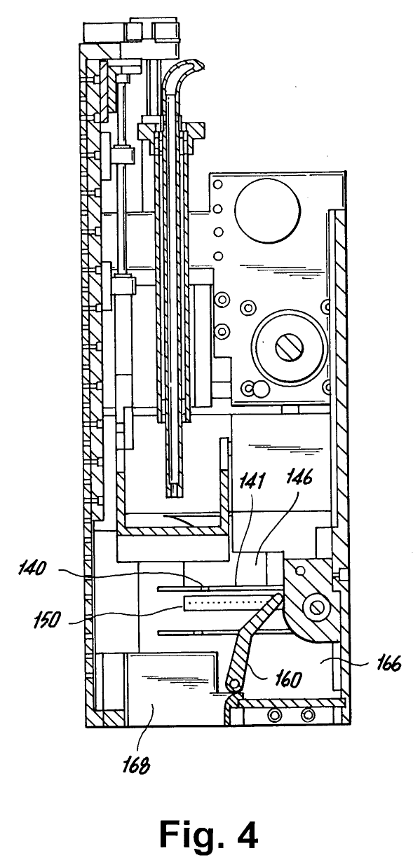

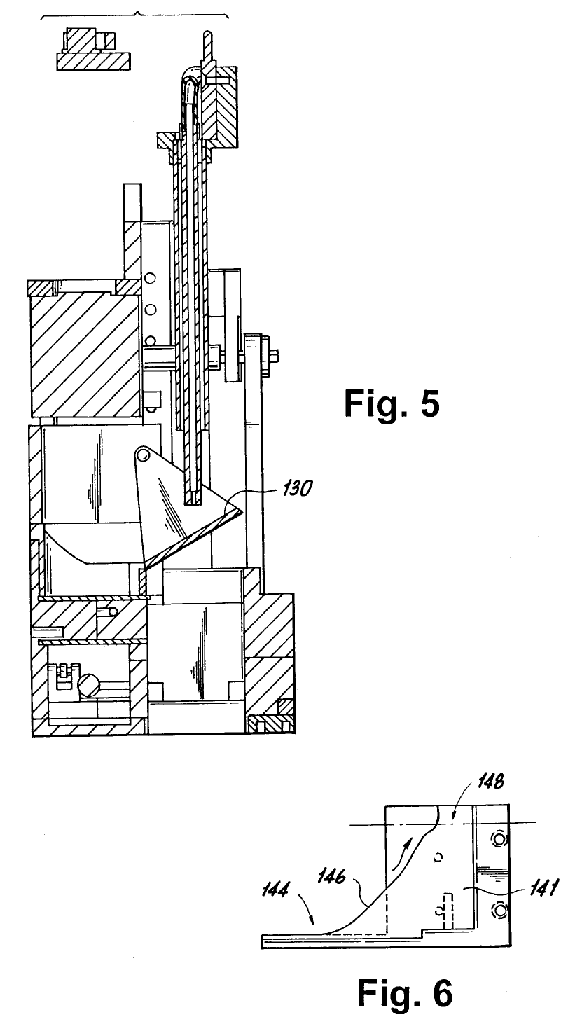

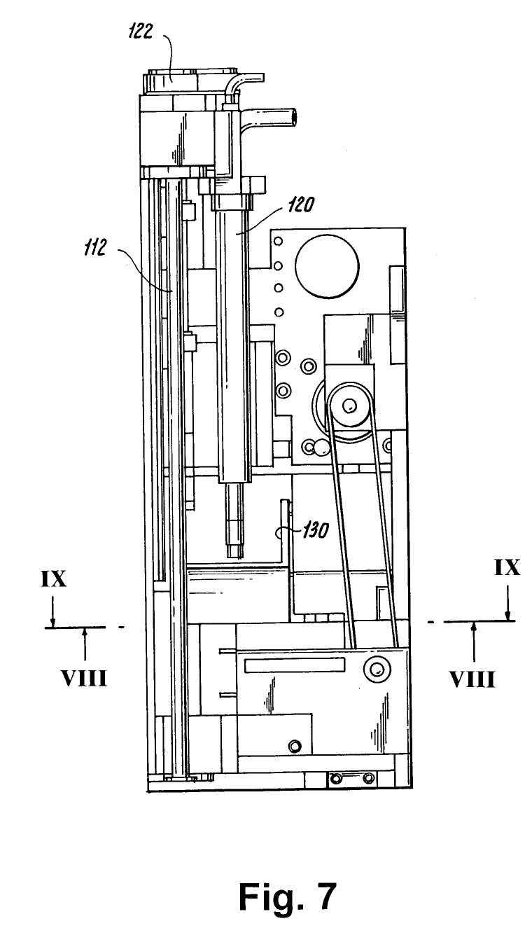

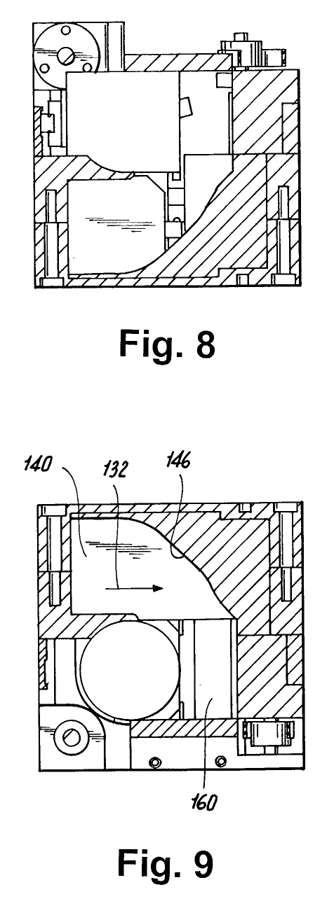

The deflector 160 of the illustrated embodiment is a rigid member having a beveled top half 164 that is proximate the transporter 140 and a bottom half that contains a pivot point that is operatively connected to an actuator 162 that causes the deflector 160 to move between the first and second positions when the deflector 160 is actuated. In one exemplary embodiment, the actuator 162 is a solenoid that is energized to move the deflector 160 from one position to the other position. Referring to FIGS. 2, 4 and 9, the deflector 160 is initially situated in the first position to allow a pill falling from the run-off edge 148 to contact and be deflected by the deflector 160 into a first receptacle 166. The first receptacle 166 stores the retrieved pills for delivery to a patient.

If the controller 180 is programmed that the patient only requires one pill, the controller 150 will generate a control signal once it receives a signal from the sensor 150 that one pill has been detected. This control signal is communicated to the deflector 160 for moving the deflector to the second position and more specifically, the control signal is sent to the solenoid 162 for actuation thereof. Actuation of the solenoid 162 moves the deflector 160 into the second position, thereby preventing any subsequent pills from entering the first receptacle 166 and simultaneously directing any subsequent pills that fall from the run-off edge 148 to a second receptacle 168. The beveled top half 164 of the deflector 160 serves to completely close off access to the first receptacle 166 and also to deflect any subsequent pills to the second receptacle 168. The second receptacle 168 stores the unwanted subsequent pills so that they can be returned to a respective pill storage container via a spring loaded trap door 170. As will be described in greater detail hereinafter, the housing 110 is preferably positioned above the pill storage containers from which the pills were retrieved by the probe 120. Upon opening the trap door 170, any excess pills are returned to the pill supply.

The detailed operation of the pill sorter 100 will now be described in detail. In operation, the controller 180 activates the probe drive system 122 in response to a request for medication entered by a health care professional. The probe 120 descends along the linear guide 112 towards the pill supply, thereby allowing the spring-loaded probe 124 and its universal probe tip 128 to enter a pill storage container. The pill storage containers are preferably maintained in a closed and locked condition, to secure their contents from access by poisons and tampering. A mechanism also activated by the controller 180, places temporarily a particular pill storage container in an open condition so that it can receive the probe tip 128. Alternatively, the pill storage container can be opened by contact between the container and probe tip 128 which serves as a tool to open the container in this embodiment.

Initially, the probe 120 rests at the uppermost point of the vertical travel axis called the starting position. The actuation of the probe drive system 122 by the controller 180 is preferably accompanied by the actuation of the vacuum source which provides suction power to the probe 120 including the spring-loaded probe 124 and the probe tip 128. The vacuum can be connected to the probe 120 through the vacuum line 114. The suction power provided by the vacuum allows the probe tip 128 to collect a pill from a pill storage container and transfer that pill to another location.

When the probe tip 128 of the spring-loaded probe 124 makes contact with a pill, a proximity sensor 116 is triggered to stop or reverse the travel direction of the spring-loaded probe 124. The proximity sensor 116 works in conjunction with a vacuum sensor which detects the amount of suction power in the vacuum tip 126 and thereby determines if the spring-loaded probe 124 has obtained a pill (a reduction in suction power means a pill has been obtained). If the vacuum sensor does not detect the presence of a pill, the spring-loaded probe 124 returns to the pill storage container to again attempt to retrieve a pill. This process is repeated until the spring-loaded probe 124 has retrieved a pill or, after several failed attempts, it has been determined that the pill storage container is empty. (The controller 180 preferably has access to a database that tracks the quantity of pills in a given pill container, and updates the database as pills are retrieved). Once the probe tip 128 has retrieved a pill, the probe housing 120 ascends with the pill safely in tow, stopping at the point where the spring-loaded probe 124 is above the pill chute 130.

As noted, the pill chute 130 is pivotable between an open and a closed position. After pills have been obtained from a pill storage container, the probe ascends and the pill chute 130 pivots into an open position to receive pills. In the illustrated embodiment, the vacuum is deactivated to release the pills from the probe tip 128 into the pill chute 130. The pill chute 130 can then return to the closed position and assist sliding the pill onto the transporter 140.

The transporter belt 141 moves the pill in the controlled direction along the sorter wall 146 to the run-off edge 148 where the pill falls through the sensor 150 and into the first receptacle 166. The sensor 150 generates a signal in response to the pill passing through and impinging upon its beams and in return, the sensor 150 sends a signal to the controller 180 which generates a control signal that causes the actuation of the solenoid 162 thereby moving the deflector 160 into the closed position.

In the situation where more than one pill is retrieved by the universal probe tip 128, illustrated in FIGS. 10-14, the transporter belt 141 moves the pills in the controlled direction while the pill sorter wall 146 urges the pills across the belt, and transverse to the controlled belt direction, towards the run-off edge 148. The pills are aligned in series in the manner previously described due to the contour of the pill sorter wall 146. Aligning pills in series prevents the pills from going through the sensor 150 at the run-off edge 148 simultaneously, thereby causing the sensor 150 to improperly sense the passage of one pill rather than the actual multiple pills that travel through the sensor 150. Instead, aligning the pills in series allows a first pill to pass through the sensor 150 alone which triggers the generation of the signal from the sensor 150 and under predetermined applications, the generation of this signal from the sensor 150 results in a control signal being generated by the controller 180. As previously mentioned, the second deflection point along the pill sorter wall 146 increases the distance between the first pill and any subsequent pills disposed on the transporter belt 141 since the traveling speed of the first pill after the second deflection point of the pill sorter wall 146 is greater than that of any subsequent pill yet to have passed the second deflection point. Increasing the distance between the pills ensures that the sensor 150 has ample time to sense and generate a signal to the controller 180 and also that the controller 180 has time to generate the control signal to position the deflector 160. The controller 180 thus actuates the solenoid 162 which positions the deflector 160 into the second position, thereby redirecting any subsequent pills to the second receptacle 168 as opposed to the first receptacle 166.

The pill sorter 100 can be constructed so that after a predetermined amount of time, the controller 180 instructs the deflector 160 to return back to the first position. The amount of time that the controller 180 waits until it deactuates the deflector 160 is variable; however, it will be appreciated that the amount of time should be a sufficient amount of time to ensure that there are no additional pills present on the conveyor belt 141. Thus, this time period is linked to the speed of the conveyor belt 141 and therefore, the time period can be computed based in part on the speed of the conveyor belt 141. For example, a time period that is equal to a ½ belt cycle (e.g., the belt moving 180°) or a full belt cycle will likely ensure that any pills that may have landed on the belt 141 at the time that the first pill was unloaded onto the conveyor belt 141 will have been delivered to the drop off location and thus would have been detected by the sensor 150. Any number of other schemes can be used to determine whether any other pills besides the first pill are present on the conveyor belt 141. After this time period has passed, the controller 180 signals the deflector 160 to return to the first position so that the next pill that passes through the drop off location is delivered to the first receptacle 166. This next pill is typically another type of pill that the patient needs in combination with the first type that was delivered first to the first receptacle 166.

It will also be appreciated that the controller 180 can be configured to permit more than one pill to be delivered to the first receptacle 166 before instructing the deflector 160 to assume the second position. For example and because the controller 180 is a programmable unit, the user can input that the patient is to receive two pills of medicine A and one pill of medicine B. The probe 120 is then instructed by the controller 180 to make two retrieving actions into the pill storage container to retrieve at least two pills. The probe 120 thus advances into the pill storage container and in the manner described hereinbefore retrieves at least one pill which is then dropped onto the conveyor belt 141. The sensor 150 then signals the controller 180 each time that one pill triggers the sensor and therefore if the first retrieval action only retrieved one pill, the sensor 150 sends only one signal to the controller 180. If more than one pill is retrieved in the first retrieval action, then the sensor 150 will send at least two signals, one for each pill sensed. In such an event, after the controller 180 receives the second signal from the sensor 150, the controller 180 instructs the deflector 160 to assume the second position and therefore, any additional pills that may be present on the conveyor belt 141 are directed to the second receptacle 168. If after a predetermined period of time, the sensor 150 does not send a second signal after the first retrieval action, then the probe 120 will perform the second retrieval action and the sensor 150 will then detect the second pill as part of the second retrieval action. As soon as the sensor 150 detects the second pill, the deflector 160 is placed in the second position. The process then continues in the manner described hereinbefore in that after a predetermined period of time, the deflector 160 is placed back in the first position, the second receptacle 168 is emptied and then the probe 120 is driven to the second pill storage container to retrieve one pill of medicine B. The process is repeated until the correct quantity of all of the medication is obtained and placed into the first receptacle 166.

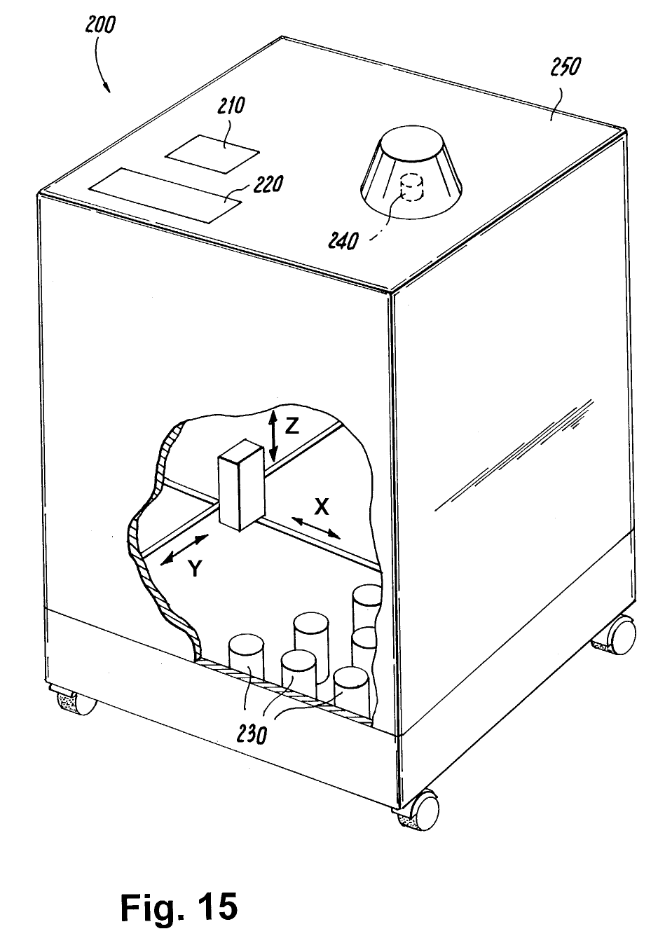

Referring to FIG. 15, the pill sorter 100 preferably is based in a rollable medication cart 200 that is used to bring a variety of medications closer to a patient, a patient's room, or whenever a dispensary might best be utilized. The cart 200 includes a user interface comprising a display and data entry panel 210, 220 at which a health care professional can identify himself or herself as well as enter and read information about a particular patient. The controller 180 can be part of the medication cart 200 in one exemplary embodiment or the interface of the cart 200 can be in communication (e.g., wireless communication) with the controller 180. The controller 180 or other processor retrieves the medication regimen for the particular patient that has been identified, and initiates the pill retrieval cycle. Specifically, the probe 120 translates along axes X- and Y- so as to position the probe tip 128 over a predetermined pill container 230 that contains the one of the pills in that patient's regimen. Translation of the probe 120 is done using conventional devices and is preferably driven by a stepper motor. The probe tip 128 descends along the Z-axis to retrieve pills from the container 230, ascends to transfer the pills to the chute 130, and the cycle repeats until the prescribed regimen for that patient is complete and the patient's pills are all disposed in the first receptacle 166. The first receptacle 166 or its contents 240 are delivered to an access associated with the cart 200, e.g., by an elevator mechanism that brings the contents 240 to a top desk 250 of the cart. For here, the user can take the first receptacle to the patient where the pill are administered.

While the invention has been particularly shown and described with reference to preferred embodiments thereof, it will be understood by those skilled in the art that various changes in form and details may be made therein without departing from the spirit and scope of the invention.

What is claimed is:

1. An apparatus for dispensing a pill, the apparatus comprising:
a first member positioned to receive at least one pill retrieved from a pill supply;
a transporter having a portion disposed proximate the first member to receive the at least one pill from the first member, the transporter constructed to align pills in series when two or more pills are simultaneously disposed on the transporter and to direct the at least one pill along a path to a first location;
a sensor proximate the first location and positioned to sense the presence of the pill as the pill passes through the first location, the sensor generating a control signal in response to the passage of the pill;
a deflector disposed proximate the first location and being positionable between first and second positions, wherein the first position diverts the at least one pill to a first receptacle and the second position diverts the at least one pill to a second receptacle; and
a controller responsive to the control signal to position the deflector in one of the first and second positions.

2. The apparatus of claim 1, further including:
a probe having a universal probe tip configured to retrieve the at least one pill from the pill supply.

3. The apparatus of claim 2, wherein the probe further comprises a vacuum source connection.

4. The apparatus of claim 2, wherein the probe is in communication with the controller and is movable along an axis so that the probe can be positioned proximate the pill supply to retrieve the at least one pill therefrom.

5. The apparatus of claim 4, wherein the probe is mounted for linear movement along the axis.

6. The apparatus of claim 2, further comprising a drive system to move the probe.

7. The apparatus of claim 2, wherein the probe includes a first detector that detects the presence of the at least one pill in the pill supply.

8. The apparatus of claim 7, wherein the first detector also detects the existence of a bottom portion of the pill supply.

9. The apparatus of claim 2, wherein the probe includes a second detector that detects whether a vacuum condition exists within the probe.

10. The apparatus of claim 9, wherein the second detector terminates the vacuum condition existing within the probe when the probe rises above the first member.

11. The apparatus of claim 1, wherein the first member is a pivotable chute having a distal end that is proximate to the transporter and a proximal end that is proximate the probe.

12. The apparatus of claim 11, wherein the pivotable chute is positionable between an open position and a closed position, the open position receives the at least one pill when the probe rises above the pivotable chute and the closed position directs the at least one pill to the transporter.

13. The apparatus of claim 11, wherein the transporter moves in a predetermined direction and includes a conveyor belt having a first end disposed near the pivotable chute and a second end at the first location.

14. The apparatus of claim 13, wherein the transporter further includes a mechanism which aligns two or more pills in series before the two or more pills reach the first location.

15. The apparatus of claim 14, wherein the mechanism further includes an arcuate-shaped surface that is situated along and minimally above the transporter and directs each pill to the first location.

16. The apparatus of claim 15, wherein the arcuate-shaped surface being defined by a wall member that extends across the conveyor-belt and permits the conveyor belt to freely move in a predetermined location.

17. The apparatus of claim 16, wherein the wall member is situated so that a pill on the conveyor belt engages the wall member.

18. The apparatus of claim 1, wherein the sensor proximate the first location is an infrared sensor within a housing situated below the transporter and includes a transmitter and a receiver.

19. The apparatus of claim 18, wherein the infrared sensor detects a pill passing through the first location after the transporter directs the pill to the first location and the pill falls off the transporter and then gravity allows the pill to pass through the first location.

20. The apparatus of claim 1, wherein the control signal instructs the controller to move the deflector from the first position to the second position.

21. The apparatus of claim 1, wherein the deflector is pivotally mounted at a proximal end and includes a beveled edge at a distal end for directing pills to the first and second receptacles.

22. The apparatus of claim 1, wherein the deflector includes a controller which is adapted to receive the control signal from the infrared sensor.

23. The apparatus of claim 22 wherein the controller is a solenoid wherein actuation of the solenoid causes the deflector to move to the first or second positions.

24. The apparatus of claim 1, wherein the deflector is initially situated in the first position and the first position diverts the pills to the first receptacle.

25. The apparatus of claim 23, wherein the solenoid receives the control signal from the infrared sensor and moves the deflector into the second position.

26 The apparatus of claim 24, wherein the first receptacle stores the pill for delivery to a patient.

27. The apparatus of claim 25, wherein the second position diverts the pills to the second receptacle.

28. The apparatus of claim 27, wherein the second receptacle stores the pills to be returned to the pill supply.

29. In a pill dispensing system, a method for handling a pill once released from a probe:
(a) discharging at least one pill to a transporter that moves the at least one pill in a controlled direction;
(b) urging the at least one pill against an abutment proximate to the transporter, the abutment arranging the at least one pill in a linear series in the controlled direction;
(c) delivering a first pill in the linear series to a first receptacle;
(d) sensing the first pill as it is delivered to the first receptacle and generating a control signal;
(e) transmitting the control signal to a deflector;
(f) positioning the deflector in response to the control signal to a closed position so that any subsequent pills in the linear series are directed elsewhere.

30. The method of claim 29, wherein the discharging step further comprises discharging the at least one pill onto a pill chute for transfer to the transporter.

31. The method of claim 30, wherein the pill chute orients the at least one pill against an abutment proximate the transporter.

32. The method of claim 29, wherein the first receptacle is flagged for delivery to a patient and the second receptacle collects extra pills for delivery back to a pill storage container.

33. A computer controlled medication cart comprising:
a housing including:
a plurality of wheels for moving the medication cart;
a plurality of drawers and means for locking the plurality of drawers to prevent unwanted access or tampering, wherein at least one of the drawers contains a plurality of pill storage containers;
the pill sorting apparatus of claim 1, wherein the pill sorting apparatus is movable within the housing in at least two directions to retrieve the one or more pills from one pill storage container; and
a user interface to provide a user access to the functions of the pill sorter.

34. The apparatus of claim 33, wherein the pill sorting apparatus is movable in the x, y and z directions.

35. The apparatus of claim 33, further including a master controller that is in wireless communication with both the controller of the pill sorting apparatus and the user interface of the cart.
